(19) United States
(12) Patent Application Publication
(10) Pub. No.: US 2009/0040145 A1
(43) Pub. Date: Feb. 12, 2009

(54) Plasma display device and driving method thereof

(76) Inventors: Inyoung Hwang, Yongin-si (KR); Chanyoung Han, Yongin-si (KR)

Correspondence Address: ROBERT E. BUSHNELL & LAW FIRM, 2029 K STREET NW, SUITE 600, WASHINGTON, DC, 20006-1004, US

(21) Appl. No.: 12/222,514

(22) Filed: Aug. 11, 2008

(30) Foreign Application Priority Data
Aug. 9, 2007 (KR) 10-2007-0079948

(51) Int. Cl. G09G 3/28

(52) U.S. Cl. 345/60

(57) ABSTRACT

A plasma display device and a driving method thereof that can prevent a low discharge by forming wall charges uniformly in the reset period. The plasma display device includes a plasma display panel including a plurality of scan electrodes; a controller configured to divide one frame into a plurality of subfields and drives each subfield by dividing each subfield into a reset period, an address period, a sustain period and a pause section; and a scan electrode driver controlled by the controller and configured to apply a reset pulse to the scan electrode in the reset period, wherein the controller sets at least one of the pause section, a first maintaining section of the reset pulse and a second maintaining section of the reset pulse in the range of over 20 μs to 110 μs.

### CLAIM OF PRIORITY

This application makes reference to, incorporates the same herein, and claims all benefits accruing under 35 U.S.C. §119 from an application for PLASMA DISPLAY DEVICE AND DRIVING METHOD THEREOF earlier filed in the Korean Intellectual Property Office on 9 Aug. 2007 and there duly assigned Serial No. 10-2007-0079948.

### BACKGROUND OF THE INVENTION

1. Field of the Invention

The present invention relates to a plasma display device, and more particularly, to a plasma display device and a driving method thereof that can prevent a low discharge by forming wall charges uniformly in a reset period.

2. Description of the Related Art

A plasma display device is a flat display device that displays a character or an image by using plasma generated by a gas discharge. A plurality of row electrodes and a plurality of column electrodes are formed on a display panel of the plasma display device and discharge cells are formed at the point where the row electrode and the column electrode intersect each other. The gray scale is expressed by controlling the discharge condition of the discharge cells.

Generally the plasma display device realizes the gray scale by dividing one frame applied to the display panel into a plurality of subfields and controlling the subfields in a time division control method. Each subfield is divided into a reset period, an address period and a sustain period.

The reset period is a period for initializing the condition of each discharge cell to perform addressing smoothly. An address period is a period for selecting the discharge cell to be emitted among the plurality of discharge cells by address discharge between the address electrode and a scan electrode. A sustain period is a period for displaying real images by discharging the discharge cells selected in the address period during a predetermined time.

However, in related art plasma display device, a reset discharge may be generated stronger more than a desirable discharge in a reset period of a subsequent subfield in case of that a large amount of priming particles exist after a previous subfield is completed. Particularly, such a strong discharge is generated more easily under the environment of high temperature. When such a strong reset discharge is generated in the reset period, the loss of wall charges becomes great. Therefore, an address discharge is not stably generated because the wall charges are not formed by the necessary amount for address discharge. Accordingly, there is a problem that a low discharge is generated because the sustain discharge becomes weak or is not generated in the sustain period.

The above information disclosed in this Related Art section is only for enhancement of understanding of the background of the invention and therefore it may contain information that does not form the prior art that is already known to a person of ordinary skill in the art.

### SUMMARY OF THE INVENTION

Accordingly, an object of the present invention is to provide a plasma display device and a driving method thereof that can prevent a low discharge by forming wall charges uniformly in a reset period.

According to one aspect of the present invention, there is provided a plasma display device which comprises, a plasma display panel including a plurality of scan electrodes; a controller controlled by the controller and configured to divide one frame into a plurality of subfields and drives each subfield by dividing each subfield into a reset period, an address period, a sustain period and a pause section; and a scan electrode driver configured to apply a reset pulse to the scan electrode in the reset period, wherein the controller sets at least one of the pause section, a first maintaining section of the reset pulse and a second maintaining section of the reset pulse in the range of over 20 μs to 110 μs.

The plasma display device may further include a section setting part built in the controller or provided additionally for setting a range of at least one of the pause section, the first maintaining section of the reset pulse and the second maintaining section of the reset pulse.

The section setting part may set the pause section in the range of 58 μs to 110 μs.

The pause section may be present between a sustain period of the subfield just before the pause section and a reset period of the subsequent subfield.

The scan electrode driver may apply a main reset pulse including a rising ramp pulse and a falling ramp pulse to the scan electrode during a main reset period of the first subfield in the plurality of subfields, and apply an auxiliary reset pulse including a rising ramp pulse of which maximum voltage is lower than the maximum voltage of the rising ramp pulse of the main reset pulse and a falling ramp pulse of which maximum voltage is lower than the maximum voltage of the falling ramp pulse of the main reset pulse to the scan electrode during auxiliary reset periods of remaining subfields except for the first subfield.

The first maintaining section of the reset pulse is a first maintaining section of the auxiliary reset pulse and may be a maintaining section for maintaining the maximum voltage of the rising ramp pulse applied during the auxiliary reset period, and the second maintaining section of the reset pulse is the second maintaining section of the auxiliary reset pulse and may be a maintaining section for maintaining the maximum voltage of the falling ramp pulse applied during the auxiliary reset period.

At least one of the first maintaining section and the second maintaining section of the auxiliary reset pulse may be set in the range of 52 μs to 110 μs.

According to another aspect of the present invention, there is provided a method for driving a plasma display device in that one frame is divided into a plurality of subfields, each subfield including a reset period, an address period, a sustain period and a pause section, which comprises: (a) initializing a plurality of discharging cells by supplying a reset pulse to a scan electrode during the reset period; (b) addressing the discharging cells to be selected from the plurality of discharging cells during the address period; (c) sustain discharge the addressed discharging cells during the sustain period; and (d) maintaining the condition of the sustain discharged discharging cells during the pause section, wherein at least one of the pause section, a first maintaining section of the reset pulse and a second maintaining section of the reset pulse is set in the range of over 20 μs to 110 μs.

The step (a) may comprise applying a main reset pulse including a rising ramp pulse and a falling ramp pulse to the scan electrode during a main reset period of the first subfield of the plurality of subfields, and applying an auxiliary reset pulse including a rising ramp pulse of which maximum voltage level is lower than the maximum voltage level of the rising ramp pulse of the main reset pulse and a falling ramp pulse of which maximum voltage level is lower than the maximum voltage level of the falling ramp pulse of the main reset pulse to the scan electrode 9 during auxiliary reset periods of remaining subfields except for the first subfield.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic block diagram illustrating a plasma display device according to one exemplary embodiment of the present invention;

FIG. 2 is a waveform diagram illustrating an example of a driving waveform showing a method for driving the plasma display device of FIG. 1;

FIG. 3 is a table illustrating a low discharge rate depending on the change of the pause section of FIG. 2;

FIG. 4 is a graph illustrating the change of the brightness depending on the change of the pause section shown in the driving waveform of FIG. 2;

FIG. 5 is a table illustrating a low discharge rate depending on the change of a first maintaining section of an auxiliary reset pulse applied during the auxiliary reset period in the driving waveform of FIG. 2; and

FIG. 6 is a table illustrating a low discharge rate depending on the change of a second maintaining section of the auxiliary reset pulse applied during the auxiliary reset period in the driving waveform of FIG. 2.

### DETAILED DESCRIPTION OF THE INVENTION

The aspects and features of the present invention and methods for achieving the aspects and features will be apparent by referring to the embodiments to be described in detail with reference to the accompanying drawings.

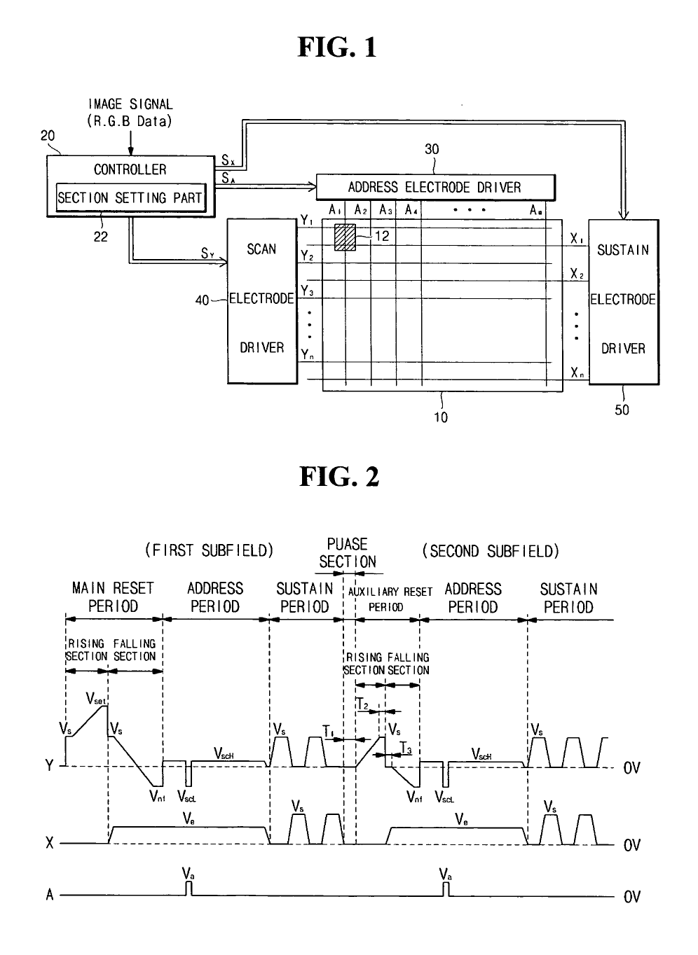

FIG. 1 is a schematic block diagram illustrating a plasma display device according to one exemplary embodiment of the present invention.

Referring to FIG. 1, the plasma display device includes a plasma display panel 10, a controller 20, an address electrode driver 30, a scan electrode driver 40 and a sustain electrode driver 50.

Referring to FIG. 1, the plasma display panel 10 includes a plurality of address electrodes (hereinafter referred to as “A electrode”) (A₁ to Aₘ) extended in column direction, and a plurality of sustain electrodes (hereinafter referred to as “X electrode”) (X₁ to Xₙ) and a plurality of scan electrodes (hereinafter referred to as “Y electrode”) (Y₁ to Yₙ) that are extended by forming pairs each other in row direction. Generally the X electrodes (X₁ to Xₙ) are formed corresponding to the Y electrodes (Y₁ to Yₙ). The X electrode and Y electrode perform an operation for display images during the sustain period. The X electrodes (X₁ to Xₙ) and Y electrodes (Y₁ to Yₙ) are arranged so as to cross orthogonally the A electrode (A₁ to Aₘ). In this case, the discharge spaces at the crossing point of the A electrodes (A₁ to Aₘ), the X electrodes (X₁ to Xₙ) and Y electrodes (Y₁ to Yₙ) form discharge cell 12. This structure of the plasma display panel 10 is an example, and so the panel of different structure can be applied to the present invention.

The controller 20 outputs an address electrode driving control signal S_{A}, a scan electrode driving control signal S_{Y} and a sustain electrode driving control signal S_{X} by receiving image signals (R, G, B data) and a synchronizing signal from the exterior. The controller 20 is driven by dividing one frame into a plurality of subfields, each of which includes a reset period, an address period, a sustain period and a pause section.

The controller 20 includes a section setting part 22 built in. Or, the section setting part 22 may be provided additionally.

The section setting part 22 controls at least one of a pause section (T₁ in FIG. 2) existing between the sustain period of the subfield just before the pause section and the reset period of next subfield, a first maintaining section (T₂ in FIG. 2) of the auxiliary reset pulse and a second maintaining section (T₃ in FIG. 2) of the auxiliary reset pulse.

Considering the case that the section setting part 22 controls the pause section (T₁ in FIG. 2), the section setting part 22 sets the pause section in the range of over 20 μs to 110 μs after the sustain period of each subfield.

As described above, according to the present invention, the section setting part 22 sets the pause section in the range of over 20 μs to 110 μs so that a large amount of priming particles formed by sustain discharge during the sustain period is sufficiently erased during the pause section. Accordingly, a weak reset discharge occurs during the reset period of next subfield, but no strong reset discharge occurs. In this case, the loss of wall charges caused by the strong reset discharge is decreased so that wall charges for address discharge to be performed during the address period become sufficient. Accordingly, the address discharge is stably generated, thereby allowing a low discharge to be prevented at the time of sustain discharge during the sustain period.

Herein, when the pause section is set to 20 μs and less, the priming particles are not sufficiently erased so that a strong reset discharge may occur during the reset period of next subfield. Then, the loss of wall charges is increased during the reset period. Accordingly, the wall charges during the address period becomes insufficient so that the low discharge may be excessively generated during the sustain period. When the pause section is set in the range of over 100 μs, the period of one frame may be extended much longer and a misfiring may occur.

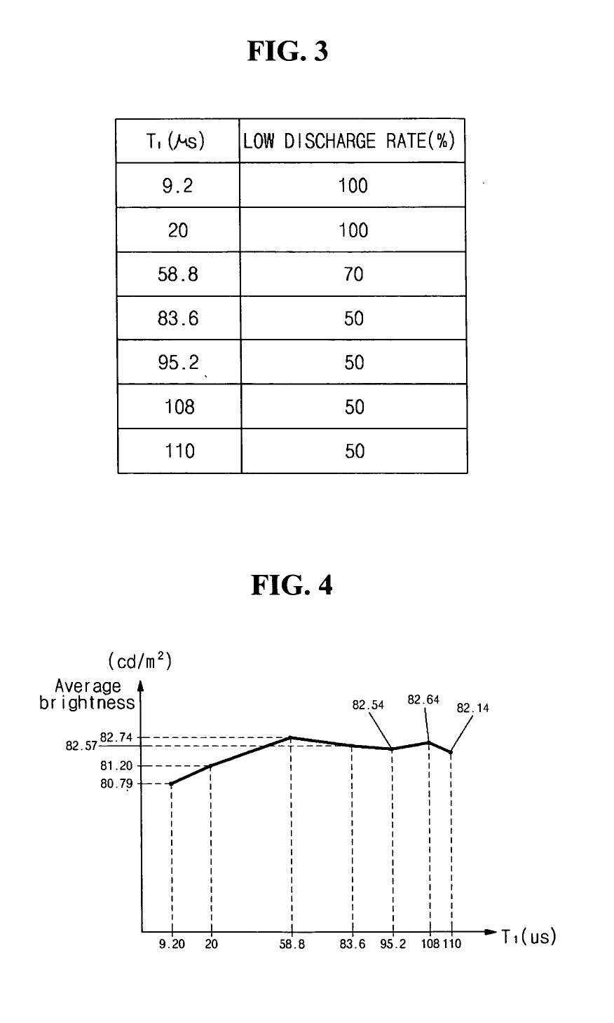

In addition, the section setting part 22 may set the pause section in the range of preferably 58 μs to 84 μs. This is because the low discharge is surely improved when the pause section is set to 58 μs. Furthermore, the pause section is preferably set to a minimum period for improving the low discharge at maximum, because there is no difference in the low discharge rate at the time of sustain discharge when the pause section is set to 84 μs or 110 μs. Accordingly, there is an effect that the sustain period can be secured longer. This will be explained with reference to FIG. 3 below.

The pause section to be set after each subfield can be controlled depending on the specification of the plasma display panel in the range of over 20 μs to 110 μs because the pause section can be different depending on the specification of the plasma display panel.

On the other hand, the section setting part 22 may set the first maintaining section (T₂ of FIG. 2) of the auxiliary reset pulse for preventing the low discharge from generating at the time of sustain discharge during the sustain period.

Considering the case that the section setting part 22 controls the first maintaining section of the auxiliary reset pulse, the section setting part 22 sets the first maintaining section (T₂ of FIG. 2) of the auxiliary reset pulse applied to the Y electrode during the reset period, that is, the maintaining section for maintaining the maximum voltage at the rising ramp pulse of the auxiliary reset pulse in the range of over 20 μs to 110 μs. Here, the auxiliary reset period is a period for initializing the cells that sustain discharge has been generated in the subfield just before the auxiliary reset period differently from the main reset period for initializing all discharge cells, and has the maximum voltage of lower level than the maximum voltage of the main reset pulse applied during the main reset period.

As described above, the section setting part 22 sets the first maintaining section of the auxiliary reset pulse in the range of over 20 μs to 110 μs so that wall charges are sufficiently formed to the electrodes after weak discharge generating during the rising section of the auxiliary reset period and wall charges are sufficiently formed to the electrodes even after the falling ramp pulse has been applied to the Y electrode during the falling section of the auxiliary reset period. Accordingly, the wall charges for address discharge to be executed during the address period are formed sufficiently so that the address discharge stably occurs. As a result, the low discharge can be prevented at the time of sustain discharge to be produced during the sustain period.

Herein, if the first maintaining section of the auxiliary reset pulse is set to 20 μs and less, the address discharge is not stably produced during the address period of next subfield when the wall charges are erased more than necessary level during the falling section because the wall charges accumulated to the electrode are little during the rising section of the auxiliary reset period. Accordingly, the low discharge rate may be high at the time of sustain discharge during the sustain period. And, when the first maintaining section of the auxiliary reset pulse is set in the range over 110 μs, the period of one frame may be extended much longer and a misfiring may occur.

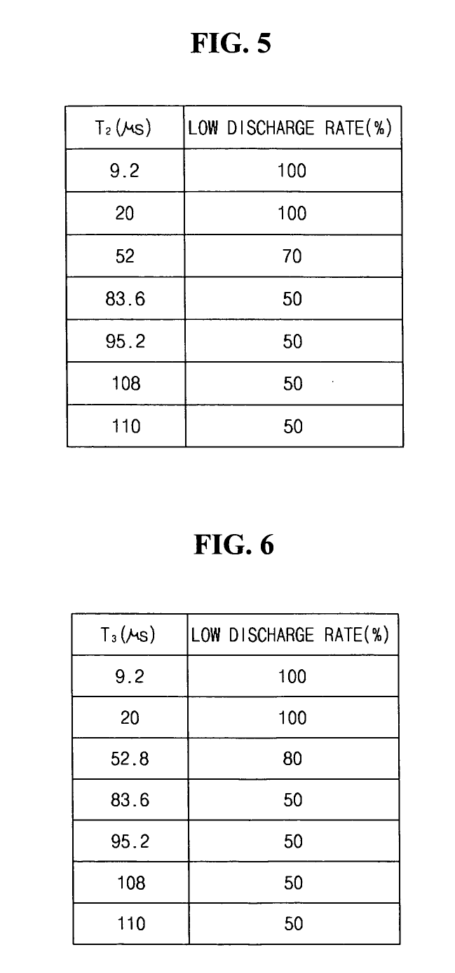

In addition, the section setting part 22 may set the first maintaining section of the auxiliary reset pulse in the range of preferably 52 μs to 84 μs. Or, the section setting part 22 may set the first maintaining section of the auxiliary reset pulse in the range of preferably 52 μs to 84 μs. This is because the low discharge rate is prominently improved when the first maintaining section of the auxiliary reset pulse is set to 52 μs. Furthermore, the first maintaining section of the auxiliary reset pulse is preferably set to a minimum period for improving the low discharge at maximum because there is no difference in the low discharge rate at the time of sustain discharge when the first maintaining section of the auxiliary reset pulse is set to 84 μs or 110 μs. Accordingly, there is a effect that the sustain period can be secured longer. This will be explained with reference to FIG. 5 below.

The first maintaining section of the auxiliary reset pulse to be set like above can be set in the range of over 20 μs to 110 μs depending on the specification of the plasma display panel because the first maintaining section of the auxiliary reset pulse can be different depending on the specification of the plasma display panel.

On the other hand, the section setting part 22 may set the second maintaining section (T₃ of FIG. 2) of the auxiliary reset pulse for preventing the low discharge from generating at the time of sustain discharge during the sustain period.

Considering the case that the section setting part 22 controls the second maintaining section of the auxiliary reset pulse, the section setting part 22 sets the second maintaining section of the auxiliary reset pulse applied to the Y electrode during the auxiliary reset period, that is, the maintaining section for maintaining the maximum voltage of the falling ramp pulse of the auxiliary reset pulse in the range of over 20 μs to 110 μs.

As described above, according to the present invention, the section setting part 22 sets the second maintaining section of the auxiliary reset pulse in the range of over 20 μs to 110 μs to induce weak reset discharge between the A electrode and the X electrode during the falling section of the auxiliary reset period so that wall charges are formed more on the A electrode. Accordingly, the address discharge stably occurs during the address period, and as a result, the low discharge can be prevented at the time of sustain discharge during the sustain period.

Herein, if the second maintaining section of the auxiliary reset pulse is set to 20 μs and less, the address discharge does not stably occur during the address period of next subfield because the wall charges accumulated to the A electrode are little after the falling section of the reset period and consequently the low discharge occurs at the time of sustain discharge during the sustain period. Accordingly, the low discharge rate is high at the time of sustain discharge. When the second maintaining section of the auxiliary reset pulse is set in the range of over 110 μs, the period of one frame may be extended much longer and a misfiring may occur.

In addition, the section setting part 22 may set the second maintaining section of the auxiliary reset pulse in the range of preferably 52 μs to 84 μs. This is because the low discharge rate is prominently improved when the second maintaining section of the auxiliary reset pulse is set to 52 μs. Furthermore, the second maintaining section of the auxiliary reset pulse is preferably set to a minimum period for improving the low discharge at maximum because there is no difference in the low discharge rate at the time of sustain discharge when the second maintaining section of the auxiliary reset pulse is set to 84 μs or 110 μs. Accordingly, there is an effect that the sustain period can be secured longer. This will be explained with reference to FIG. 6 below.

The second maintaining section of the auxiliary reset pulse to be set like above can be controlled in the range of over 20 μs to 110 μs depending on the kind of the plasma display panel because the second maintaining section of the auxiliary reset pulse can be different depending on the specification of the plasma display panel.

The plasma display device according to the present invention can control all of the pause section, the first maintaining section of the auxiliary reset pulse and the second maintaining section of the auxiliary reset pulse so as to prevent the low discharge from generating at the time of sustain discharge by generating the stable address discharge using the section setting part 22, but in this case, some stress may be applied to circuit elements. Hence, the section setting part 22 may select and control any one of the pause section, the first maintaining section of the auxiliary reset pulse and the second maintaining section of the auxiliary reset pulse so as not to apply stress to the circuit elements.

Furthermore, the plasma display device according to the present invention can prevent 8 the low discharge from generating at the time of sustain discharge without inducing stress to circuit elements by maintaining the set potential as it is not by changing the potential at the time of controlling the pause section, the first maintaining section of the auxiliary reset pulse and the second maintaining section of the auxiliary reset pulse.

The address electrode driver 30 generates a display data signal by processing the address electrode driving control signal S_{A} of the driving control signals S_{A}, S_{Y} and S_{X} from the controller 20, and supplies the display data signal to the A electrodes.

The scan electrode driver 40 supplies the scan pulse generated by processing the scan electrode driving control signal S_{Y} of the driving control signals S_{A}, S_{Y} and S_{X} from the controller 20 to the Y electrodes.

The sustain electrode driver 50 supplies the sustain pulse generated by processing the sustain electrode driving control signal S_{X} of the driving control signals S_{A}, S_{Y} and S_{X} from the controller 20 to the X electrodes.

FIG. 2 is a waveform diagram illustrating an example of a driving waveform showing a method for driving the plasma display device of FIG. 1, and FIG. 3 is a table illustrating a low discharge rate depending on the change of the pause section of FIG. 2, and FIG. 4 is a graph illustrating the change of the brightness depending on the change of the pause section shown in the driving waveform of FIG. 2

FIG. 2 shows a driving waveform of two subfields of the plurality of subfields forming one frame. The reset period of the first subfield is illustrated as a main reset period, and the reset period of the second subfield is illustrated as an auxiliary reset period. Further, for the convenience, only the driving waveform applied to the Y, X and A electrodes that form one cell will be explained.

In the driving waveform for driving the plasma display device according to one exemplary embodiment of the present invention, one frame is divided into a plurality of subfields, for example, 8 to 11 of subfields. Each subfield includes a reset period, an address period, a sustain period and a pause section.

The reset period is a period for initializing discharge cells, and includes a main reset period and a auxiliary reset period. Herein, the main reset period is a reset period that can generate reset discharge for the all discharge cells. The auxiliary reset period is a reset period that can generate reset discharge for the discharge cell in which sustain discharge has occurred in the subfield just before the auxiliary reset period. The address period is a period for selecting the discharge cell to be displayed among the discharge cells, and the sustain period is a period for discharging the discharge cell selected during the address period. The pause section is a section for maintaining the condition of the discharge cell in which sustain discharge has occurred during the sustain period, and in the pause section, discharging does not occur.

The main reset period of the first subfield is the period that a reset pulse (hereinafter, referred to as “main reset pulse”) erased after wall charges have been accumulated on all the discharge cells is applied to, and includes a rising section and a falling section. In the rising section, a voltage of a rising ramp pulse that rises gradually to a voltage Vₛₑₜ beyond the firing voltage from a voltage Vₛ is applied to the Y electrode under condition of maintaining X electrode at 0 V. Then, a weak reset discharge occurs between the Y electrode and the A electrode, and between the Y electrode and the X electrode and simultaneously, negative (−) wall charges are formed on the Y electrode and positive (+) wall charges are formed on the A electrode and X electrode.

In the falling section of the main reset period of the first subfield, a voltage of a falling ramp pulse that falls gradually to a voltage V_{nf} from the voltage Vₛ is applied to the Y electrode under condition of maintaining X electrode at a voltage Vₑ. Then, while the voltage of the Y electrode is decreased, a weak reset discharge occurs between the Y electrode and the X electrode, and between the Y electrode and the A electrode, and simultaneously, the negative (−) wall charges formed on the Y electrode and the positive (+) wall charges formed on the A electrode and X electrode are erased. Herein, the wall charges are not completely erased, and are uniformly distributed on the entire area of the discharge cells and simultaneously the number decrease. The Y electrode is maintained to the voltage V_{nf} until entering into the address period after the falling section.

Next, in the address period of the first subfield, a scan pulse having a voltage V_{scL} and an address pulse having a voltage Vₐ are applied to the Y electrode and the A electrode respectively for selecting discharge cell to be turned on. The Y electrode that is not selected is biased to a voltage V_{scH} higher than the voltage V₅CL and 0 V is applied to the A electrode of the cell that is not turned on. Then, the address discharge occurs by the difference between the voltage Vₐ and the voltage V₅CL and wall voltage due to the wall charges formed on the A electrode and the Y electrode. As a result, positive (+) wall charges are formed on the Y electrode and negative (−) wall charges are formed on the X electrode. Further, negative (−) wall charges are also formed on the A electrode.

Next, the sustain pulse of the voltage Vₛ is alternatively applied to the Y electrode and the X electrode. In this case, the sustain pulse is a pulse for making the difference between the voltages of the Y electrode and the X electrode to be alternatively the voltage Vₛ or a voltage −Vₛ, and pulses applied to the Y electrode and the X electrode are the same width.

If the wall voltage has been formed between the Y electrode and the X electrode by address discharge during the previous address period, the sustain discharge occurs at the Y electrode and the X electrode by the wall voltage and the voltage Vₛ. Herein, the process for applying the sustain pulse of the voltage Vₛ to the Y electrode and the process for applying the voltage Vₛ to the X electrode are repeated by the number corresponding to the weight value that the subfield displays.

On the other hand, when the last sustain pulse is applied to the X electrode, positive (+) wall charges are formed to the Y electrode after the last sustain discharge and negative (−) wall charges are formed to the X electrode.

Like this, when the sustain period of the first subfield is finished, the second subfield is started. In this time, a pause section T₁ exists before the second subfield begins, that is, between the last sustain pulse and the second subfield. The pause section T₁ is set in the range of over 20 μs to 110 μs by the section setting part 22 of FIG. 1. Accordingly, the priming particles formed by the sustain discharge T₁ are sufficiently erased in the pause section and positive (+) wall charges are more formed to the Y electrode. So, in next subfield, for example, in the auxiliary reset period of the second subfield, the loss of the wall charges caused by strong reset discharge can be reduced by strengthen weak reset discharge not strong reset discharge. Because the loss of the wall charges are reduced, the address discharge stably occurs during the subsequent address period so that the low discharge can be prevented at the time of sustain discharge during the sustain period.

Referring to FIG. 3, the low discharge rate is high as 100% when the pause section T₁ is 20 μs and less, and the low discharge rate is prominently decreased from 58.8 μs. As shown in FIG. 4, the brightness becomes rapidly high when the pause section T₁ is 58.8 μs.

On the other hand, as shown in FIG. 3, the low discharge rate is constant as 50% from when the pause section T₁ is more than 83.6 μs. As shown in FIG. 4, the brightness is almost not changed when the pause section T₁ is more than 83.6 μs.

Accordingly, the pause section T₁ may be set in the range of preferably 58 μs to 84 μs considering the low discharge rate and the change of the brightness depending on the change of the pause section shown in FIGS. 3 and 4.

The auxiliary reset period of the second subfield and the subsequent subfield is a period in which a reset pulse (hereinafter referred to as “auxiliary reset pulse”) is applied so as to generate the reset discharge only when the sustain discharge has occurred in the subfield just before the auxiliary reset period, and includes a rising section and a falling section.

In the rising section of the auxiliary reset period, a voltage of a rising ramp pulse that rises gradually from the voltage 0V to the voltage Vₛ is applied to the Y electrode under condition of maintaining X electrode at 0 V. In this case, when the sustain discharge has occurred in the sustain period of the first subfield, because positive (+) wall charges are formed on the Y electrode and negative (−) wall charges are formed on the X electrode and the Y electrode, a weak reset discharge occurs respectively between the Y electrode and the X electrode and between the Y electrode and the A electrode which the voltage of the Y electrode gradually increases. Accordingly, negative (−) wall charges are formed on the Y electrode and positive (+) wall charges are formed on the A electrode and X electrode. Herein, because discharge occurs in all the discharge cells when the voltage of the Y electrode is increased to the voltage Vₛₑₜ, the voltage of the Y electrode is set to the voltage Vₛ lower than the voltage Vₛₑₜ.

In this embodiment of the present invention, the pause section T₁ has been set more longer than the prior art by the section setting part 22 so as to prevent the low discharge at the time of sustain discharge by generating stable address discharge. However, the first maintaining section T₂ of the auxiliary reset pulse may be set longer than the prior art. The setting of the first maintaining section T₂ of the auxiliary reset pulse will be described in detail with reference to FIG. 5 hereinafter.

In the falling section of the auxiliary reset period, a voltage of a falling ramp pulse that falls gradually from the voltage 0V to the voltage V_{nf} is applied to the Y electrode under condition of maintaining X electrode at a voltage Vₑ. Then, while the voltage of the Y electrode is decreased, a weak reset discharge occurs between the Y electrode and the X electrode, and between the Y electrode and the A electrode, and simultaneously, the negative (−) wall charges formed on the Y electrode and the positive (+) wall charges formed on the A electrode and X electrode are erased. Herein, because the voltage V_{nf} of the Y electrode is the same as the voltage V_{nf} of the falling section of the first subfield, it becomes substantially same to the condition of the wall charges after completion of the falling section of the first subfield.

In this embodiment of the present invention, the pause section T₁ or the first maintaining section T₂ of the auxiliary reset pulse has been set more longer than the prior art by the section setting part 22 so as to prevent the low discharge at the time of sustain discharge by generating stable address discharge. However, the second maintaining section T₃ of the auxiliary reset pulse may be set longer than the prior art. The setting of the second maintaining section T₃ of the auxiliary reset pulse will be described in detail with reference to FIG. 6 below.

As the address period and the sustain period of the second subfield are same as the first subfield, the detailed explanation will be omitted. Merely, in the maintaining section of the second subfield, the sustain pulses are applied to the Y electrode and the X electrode with reversed phase by the number corresponding to the weight value that the corresponding subfield displays. Not only the same waveform as in the second subfield may be applied in the remaining subfield to be continued, as well as the same waveform as in the first subfield may be applied in any subfield.

FIG. 5 is a table illustrating a low discharge rate depending on the change of the first maintaining section of the auxiliary reset pulse applied during an auxiliary reset period in the driving waveform of FIG. 2.

Referring to FIG. 5, the low discharge rate is high as 100% when the first maintaining section T₂ of the auxiliary reset pulse is 20 μs and less, and the low discharge rate is prominently decreased from 52 μs. However, the low discharge rate is constant as 50% from when the first maintaining section T₂ of the auxiliary reset pulse is more than 83.6 μs.

Accordingly, the first maintaining section T₂ of the auxiliary reset pulse may be set in the range of preferably 52 μs to 84 μs, considering the low discharge rate depending on the first maintaining section T₂ of the auxiliary reset pulse shown in FIG. 5.

When the first maintaining section T₂ of the auxiliary reset pulse is set in the range of over 20 μs to 110 μs, negative (−) wall charges may be formed more to the Y electrode after a weak reset discharge occurring during the rising section of the auxiliary reset period. Accordingly, negative (−) wall charges are sufficiently formed on the Y electrode even after a falling ramp pulse has been applied to the Y electrode during the falling section of the auxiliary reset period. As negative (−) wall charges are sufficiently formed on the Y electrode at the time of completion of the auxiliary reset period, the address discharge stably occurs during the subsequent address period between the Y electrode and A electrode so that the low discharge can be prevented at the time of sustain discharge during the sustain period.

FIG. 6 is a table illustrating a low discharge rate depending on the change of the second maintaining section of the auxiliary reset pulse applied during the auxiliary reset period in the driving waveform of FIG. 2.

Referring to FIG. 6, the low discharge rate is high as 100% when the second maintaining section T₃ of the auxiliary reset pulse is 20 μs and less, and the low discharge rate is prominently decreased from 52.8 μs. However, the low discharge rate is constant as 50% from when the second maintaining section T₃ of the auxiliary reset pulse is more than 83.6 μs.

Accordingly, the second maintaining section T₃ of the auxiliary reset pulse may be set in the range of preferably 52 μs to 84 μs, considering the low discharge rate depending on the second maintaining section T₃ of the auxiliary reset pulse shown in FIG. 6.

When the second maintaining section T₃ of the auxiliary reset pulse is set in the range of over 20 μs to 110 μs, positive (+) wall charges are formed more to the A electrode because a weak discharge is induced between the A electrode and the X electrode after the rising section of the auxiliary reset period. The address discharge stably occurs during the subsequent address period between the Y electrode and the A electrode so that the low discharge can be prevented at the time of sustain discharge during the sustain period.

On the other hand, as shown in FIG. 2, it is illustrated that the first and second maintaining sections T₂ and T₃ of the auxiliary reset pulse applied during the auxiliary reset period of the second subfield are controlled, but the present invention may be applicable to the reset period of the remaining subfield that the auxiliary reset pulse is applied to.

In addition, in the present invention, the first and second maintaining sections T₂ and T₃ of the auxiliary reset pulse are set for example, but the first and second maintaining section of the main reset pulse may be set in the range of over 20 μs to 110 μs. In this case, the subsequent address discharge may stably occur so that the low discharge can be prevented at the time of sustain discharge.

As described above, the plasma display device and the driving method thereof according to the present invention produces the following effects.

First, by setting at least one of the pause section existing between the subfields, the first maintaining section and the second maintaining section of the auxiliary reset pulse in the range of over 20 μs to 110 μs, the address discharge stably occurs, thereby allowing the low discharge to be prevented at the time of sustain discharge.

Second, by maintaining the set potential without changing the potential at the time of controlling the pause section, the first maintaining section and the second maintaining section of the auxiliary reset pulse, the low discharge can be prevented without inducing stress to the elements.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. A plasma display device comprising:
a plasma display panel including a plurality of scan electrodes;
a controller configured to divide one frame into a plurality of subfields and drives each subfield by dividing each subfield into a reset period, an address period, a sustain period and a pause section; and
a scan electrode driver controlled by the controller and configured to apply a reset pulse to the scan electrode in the reset period, wherein
the controller sets at least one of the pause section, a first maintaining section of the reset pulse and a second maintaining section of the reset pulse in the range of over 20 μs to 110 μs.

2. The plasma display device of claim 1, further comprising: a section setting part, built in the controller or provided additionally, configured to set a range of at least one of the pause section, the first maintaining section of the reset pulse and the second maintaining section of the reset pulse.

3. The plasma display device of claim 2, wherein the section setting part sets the pause section in the range of 58 μs to 110 μs.

4. The plasma display device of claim 3, wherein the pause section exists between a sustain period of the subfield just before the pause section and a reset period of the subsequent subfield.

5. The plasma display device of claim 2, wherein the scan electrode driver applies a main reset pulse including a rising ramp pulse and a falling ramp pulse to the scan electrode during a main reset period of the first subfield in the plurality of subfields, and applies an auxiliary reset pulse including a rising ramp pulse of which maximum voltage is lower than the maximum voltage of the rising ramp pulse of the main reset pulse and a falling ramp pulse of which maximum voltage is lower than the maximum voltage of the falling ramp pulse of the main reset pulse to the scan electrode during auxiliary reset periods of remaining subfields except for the first subfield.

6. The plasma display device of claim 5, wherein the first maintaining section of the reset pulse is the first maintaining section of the auxiliary reset pulse and is a maintaining section for maintaining the maximum voltage of the rising ramp pulse applied during the auxiliary reset period, and
the second maintaining section of the reset pulse is the second maintaining section of the auxiliary reset pulse and is a maintaining section for maintaining the maximum voltage of the falling ramp pulse applied during the auxiliary reset period.

7. The plasma display device of claim 6, wherein at least one of the first maintaining section and the second maintaining section of the auxiliary reset pulse is set in the range of 52 μs to 110 μs.

8. A method for driving a plasma display device in that one frame is divided into a plurality of subfields, and each subfield includes a reset period, an address period, a sustain period and a pause section, comprising:
(a) initializing a plurality of discharging cells by supplying a reset pulse to a scan electrode during the reset period;
(b) addressing the discharging cells to be selected from the plurality of discharging cells during the address period;
(c) sustain discharge the addressed discharging cells during the sustain period; and
(d) maintaining the condition of the sustain discharged discharging cells during the pause section,
wherein at least one of the pause section, a first maintaining section of the reset pulse and a second maintaining section of the reset pulse is set in the range of over 20 μs to 110 μs.

9. The method for driving a plasma display device of claim 8, wherein the pause section is set in the range of 58 μs to 110 μs.

10. The method for driving a plasma display device of claim 8, wherein the step (a) comprises:
applying a main reset pulse including a rising ramp pulse and a falling ramp pulse to the scan electrode during a main reset period of the first subfield of the plurality of subfields; and
applying an auxiliary reset pulse including a rising ramp pulse of which maximum voltage level is lower than the maximum voltage level of the rising ramp pulse of the main reset pulse and a falling ramp pulse of which maximum voltage level is lower than the maximum voltage level of the falling ramp pulse of the main reset pulse to the scan electrode during auxiliary reset periods of remaining subfields except for the first subfield.

11. The method for driving a plasma display device of claim 10, wherein the first maintaining section of the reset pulse is the first maintaining section of the auxiliary reset pulse and is a maintaining section for maintaining the maximum voltage of the rising ramp pulse applied during the auxiliary reset period, and
the second maintaining section of the reset pulse is the second maintaining section of the auxiliary reset pulse and is a maintaining section for maintaining the maximum voltage of the falling ramp pulse applied during the auxiliary reset period.

12. The method for driving a plasma display device of claim 11, wherein at least one of the first maintaining section and the second maintaining section of the auxiliary reset pulse is set in the range of 52 μs to 110 μs.

13. A plasma display device, comprising:
a plasma display panel including a plurality of scan electrodes;
a controller configured to divide one frame into a plurality of subfields and drives each subfield by dividing each subfield into a reset period, an address period, a sustain period and a pause section; and
a scan electrode driver controlled by the controller and configured to apply a reset pulse to the scan electrode in the reset period, wherein
the controller sets a portion of the pause section as a first maintaining section of the reset pulse and a second maintaining section of the reset pulse in a first time period, wherein
the pause section is set to a second time period.

14. The plasma display device recited in claim 13, wherein the first time period is in a range of over 20 μs to 110 μs.

15. The plasma display device recited in claim 13, wherein the second time period is in a range of 58 μs to 110 μs.
